(19) United States
(12) Patent Application Publication
(10) Pub. No.: US 2023/0229946 A1
(43) Pub. Date: Jul. 20, 2023

(54) METHODS FOR GENERATING AND PROVIDING CAUSAL EXPLANATIONS OF ARTIFICIAL INTELLIGENCE MODELS AND DEVICES THEREOF

(71) Applicant: Georgia Tech Research Corporation, Atlanta, GA (US)

(72) Inventors: Matthew O'Shaughnessy, Atlanta, GA (US); Gregory Canal, Atlanta, GA (US); Marissa Connor, Atlanta, GA (US); Mark Davenport, Atlanta, GA (US); Christopher John Rozell, Atlanta, GA (US)

(21) Appl. No.: 18/011,629

(22) PCT Filed: Jun. 24, 2021
(86) PCT No.: PCT/US2021/038884

§ 371 Date: Dec. 20, 2022

Related U.S. Application Data
(60) Provisional application No. 63/043,331, filed on Jun. 24, 2020.

(51) Int. Cl. G06N 5/045

(52) U.S. Cl. CPC G06N 5/045

(57) ABSTRACT

Methods, non-transitory computer readable media, and causal explanation computing apparatus that assists with generating and providing causal explanation of artificial intelligence models includes obtaining a dataset as an input for an artificial intelligence model, wherein the obtained dataset is filtered to a disentangled low-dimensional representation. Next, a plurality of first factors from the disentangled low-dimensional representation of the obtained data that affect an output of the artificial intelligence model is identified. Further, a generative mapping from the disentangled low-dimensional representation between the identified plurality of first factors and the output of the artificial intelligence model, using causal reasoning is determined. An explanation data is generated using the determined generative mapping, wherein the generated explanation data provides a description of an operation leading to the output of the artificial intelligence model using the identified plurality of first factors. The generated explanation data is provided via a graphical user.

This application claims the benefit of U.S. Provisional Patent Application Ser. No. 63/043,331, filed Jun. 24, 2020, which is hereby incorporated by reference in its entirety.

### STATEMENT REGARDING GOVERNMENT SPONSORED RESEARCH

This invention was made with government support under Agreement No. CCF-1350954, awarded by National Science Foundation. The government has certain rights in the invention.

### FIELD

The disclosed technology relates to artificial intelligence, and particularly relates to generating and providing causal explanations of artificial intelligence models and devices thereof.

### BACKGROUND

There is a growing consensus among researchers, ethicists, and the public that machine learning models deployed in sensitive applications should be able to explain their decisions. A powerful way to make “explain” mathematically precise is to use the language of causality: explanations should identify causal relationships between certain aspects of the input data and the classifier output.

Constructing these causal explanations requires reasoning about how changing different aspects of the input data affects the classifier output, but these observed changes are only meaningful if the modified combination of aspects occurs naturally in the dataset. A challenge in constructing causal explanations is therefore the ability to change certain aspects of data samples without leaving the data distribution.

### SUMMARY

The disclosed technology can generate and provide causal post-hoc explanations of artificial intelligence models based on a learned low-dimensional representation of the data. In the examples of the disclosed technology, the explanation can be causal in the sense that changing learned latent factors produces a change in the classifier output statistics. To construct these explanations, in the examples of the disclosed technology, a learning framework that leverages a generative model and information- theoretic measures of causal influence can be designed. Further, the disclosed technology encourages both the generative model to represent the data distribution and the latent factors to have a large causal influence on the classifier output. Additionally, the disclosed technology can learn both global and local explanations, can be compatible with any classifier that admits class probabilities and a gradient, and does not require labeled attributes or knowledge of causal structure.

An exemplary embodiment of the present disclosure provides a method for generating and providing causal explanations of artificial intelligence models comprising, obtaining a dataset as an input for an artificial intelligence model, wherein the obtained dataset is filtered to a disentangled low-dimensional representation. Next, a plurality of first factors from the disentangled low-dimensional representation of the obtained data that affect an output of the artificial intelligence model can be identified by the causal explanation computing apparatus. Further, a generative mapping from the disentangled low-dimensional representation between the identified plurality of first factors and the output of the artificial intelligence model, using causal reasoning can be determined by the causal explanation computing apparatus. An explanation data can be generated by the causal explanation computing apparatus using the determined generative mapping, wherein the generated explanation data can provide a description of the output of the artificial intelligence model using the identified plurality of first factors. The generated explanation data can be provided via a graphical user interface by the causal explanation computing apparatus.

In any of the embodiments disclosed herein, the method can further comprise: learning, by the causal explanation computing apparatus, the generated generative mapping data to generate the explanation data comprising the one or more decision factors; and identifying, by the causal explanation computing apparatus, a plurality of second factors within the obtained data, wherein the identified plurality of second factors have lesser impact on the output of the artificial intelligence model when compared to the identified plurality of first factors.

In any of the embodiments disclosed herein, the method can comprise: defining, by the causal explanation computing apparatus, a causal model representing a relationship between the identified plurality of first factors, the plurality of second factors, and the output of the artificial intelligence model; defining, by the causal explanation computing apparatus, a quantifying metric to quantify the causal influence of the identified plurality of first factors on the output of the artificial intelligence model; and defining, by the causal explanation computing apparatus, a learning framework.

In any of the embodiments disclosed herein, the method can comprise: describing a functional causal structure of the dataset, and deriving an explanation from an indirect causal link from the identified plurality of first factors and the output of the artificial intelligence model.

In any of the embodiments disclosed herein, the method can comprise defining the quantifying metric considering a factor to capture functional dependencies and quantify indirect causal relationship between the identified plurality of first factors and the output of the artificial intelligence model.

In any of the embodiments disclosed herein, the method can comprise the identified plurality of second factors not affecting the output of the artificial intelligence model.

Another embodiment of the present disclosure provides a non-transitory computer readable medium having stored thereon instructions comprising machine executable code which when executed by at least one processor, can cause the processor to perform steps including obtaining a dataset as an input for an artificial intelligence model, wherein the obtained dataset can be filtered to a disentangled low-dimensional representation. Next, a plurality of first factors from the disentangled low-dimensional representation of the obtained data that affect an output of the artificial intelligence model can be identified. Further, a generative mapping from the disentangled low-dimensional representation between the identified plurality of first factors and the output of the artificial intelligence model, using causal reasoning can be determined. An explanation data can be generated using the determined generative mapping, wherein the generated explanation data can provide a description of the output of the artificial intelligence model using the identified plurality of first factors. The generated explanation data can be provided via a graphical user interface.

In any of the embodiments disclosed herein, the non-transitory computer readable medium can further comprise: learning, by the causal explanation computing apparatus, the generated generative mapping data to generate the explanation data comprising the one or more decision factors; and identifying, by the causal explanation computing apparatus, a plurality of second factors within the obtained data, wherein the identified plurality of second factors have lesser impact on the output of the artificial intelligence model when compared to the identified plurality of first factors.

In any of the embodiments disclosed herein, the non-transitory computer readable medium can comprise: defining, by the causal explanation computing apparatus, a causal model representing a relationship between the identified plurality of first factors, the plurality of second factors, and the output of the artificial intelligence model; defining, by the causal explanation computing apparatus, a quantifying metric to quantify the causal influence of the identified plurality of first factors on the output of the artificial intelligence model; and defining, by the causal explanation computing apparatus, a learning framework.

In any of the embodiments disclosed herein, the non-transitory computer readable medium can comprise: describing a functional causal structure of the dataset, and deriving an explanation from an indirect causal link from the identified plurality of first factors and the output of the artificial intelligence model.

In any of the embodiments disclosed herein, the non-transitory computer readable medium can comprise defining the quantifying metric considering a factor to capture functional dependencies and quantify indirect causal relationship between the identified plurality of first factors and the output of the artificial intelligence model.

In any of the embodiments disclosed herein, the non-transitory computer readable medium can comprise the identified plurality of second factors not affecting the output of the artificial intelligence model.

A causal explanation computing apparatus including one or more processors coupled to a memory and configured to be capable of executing programmed instructions comprising obtaining a dataset as an input for an artificial intelligence model, wherein the obtained dataset can be filtered to a disentangled low-dimensional representation. Next, a plurality of first factors from the disentangled low-dimensional representation of the obtained data that affect an output of the artificial intelligence model can be identified. Further, a generative mapping from the disentangled low-dimensional representation between the identified plurality of first factors and the output of the artificial intelligence model, using causal reasoning can be determined. An explanation data can be generated using the determined generative mapping, wherein the generated explanation data can provide a description of the output of the artificial intelligence model using the identified plurality of first factors. The generated explanation data can be provided via a graphical user interface.

In any of the embodiments disclosed herein, the causal explanation computing apparatus can further comprise: learning, by the causal explanation computing apparatus, the generated generative mapping data to generate the explanation data comprising the one or more decision factors; and identifying, by the causal explanation computing apparatus, a plurality of second factors within the obtained data, wherein the identified plurality of second factors have lesser impact on the output of the artificial intelligence model when compared to the identified plurality of first factors.

In any of the embodiments disclosed herein, the causal explanation computing apparatus can comprise: defining, by the causal explanation computing apparatus, a causal model representing a relationship between the identified plurality of first factors, the plurality of second factors, and the output of the artificial intelligence model; defining, by the causal explanation computing apparatus, a quantifying metric to quantify the causal influence of the identified plurality of first factors on the output of the artificial intelligence model; and defining, by the causal explanation computing apparatus, a learning framework.

In any of the embodiments disclosed herein, the causal explanation computing apparatus can comprise: describing a functional causal structure of the dataset, and deriving an explanation from an indirect causal link from the identified plurality of first factors and the output of the artificial intelligence model.

In any of the embodiments disclosed herein, the causal explanation computing apparatus can comprise defining the quantifying metric considering a factor to capture functional dependencies and quantify indirect causal relationship between the identified plurality of first factors and the output of the artificial intelligence model.

In any of the embodiments disclosed herein, the causal explanation computing apparatus can comprise the identified plurality of second factors not affecting the output of the artificial intelligence model.

By using the techniques discussed in greater detail below, the disclosed technology can provide a generative framework for learning a rich and flexible vocabulary to explain artificial intelligence models, and a method that uses this vocabulary and causal modeling to construct explanations. The disclosed technology can learn explanatory factors that have a causal, not correlational, relationship with the classifier, and the information-theoretic measure of causality that allows to completely capture complex causal relationships.

Applying the disclosed technology can require selecting a generative model architecture, and then training this generative model using data relevant to the classification task. The data used to train the explainer may be the original training set of the classifier, but more generally it can be any dataset; the resulting explanation can reveal the aspects in that specific dataset that are relevant to the classifier. In the examples discussed, a generative model g with appropriate capacity can be required to be selected. Underestimating this capacity could reduce the effectiveness of the resulting explanations, while overestimating this capacity can needlessly increase the training cost.

Additionally, the disclosed technology can combine generative and causal modeling. Furthermore, the disclosed technology can address two common challenges in counterfactual explanation: a computationally infeasible search in input space can be avoided because a low-dimensional set of latent factors that can be optimized, and ensuring that perturbations result in a valid data point.

### BRIEF DESCRIPTION OF THE DRAWINGS

FIG. 1 is a block diagram of a network including a causal explanation computing apparatus for generating and providing causal explanations of artificial intelligence models, in accordance with some embodiments of the present disclosure;

FIG. 2 is a block diagram of the causal explanation computing apparatus shown in FIG. 1, in accordance with some embodiments of the present disclosure;

FIG. 3 is an exemplary block diagram illustrating a computational architecture used to learn explanations, in accordance with some embodiments of the present disclosure;

FIG. 4 is an exemplary block diagram illustrating a directed acyclic graph representing a causal model, in accordance with some embodiments of the present disclosure;

FIG. 5 is an exemplary algorithm for selecting select K, L, and X, in accordance with some embodiments of the present disclosure;

FIGS. 6A-6D is an exemplary graph illustrating simple classifiers in R2, in accordance with some embodiments of the present disclosure;

FIGS. 7A-7D is an exemplary visualizations of the learned latent factors, in accordance with some embodiments of the present disclosure;

FIGS. 8A-8D is an exemplary visualizations of the disclosed technology; and

FIG. 9 is a flowchart of an exemplary method for generating and providing causal explanations of artificial intelligence models, in accordance with some embodiments of the present disclosure.

### DETAILED DESCRIPTION

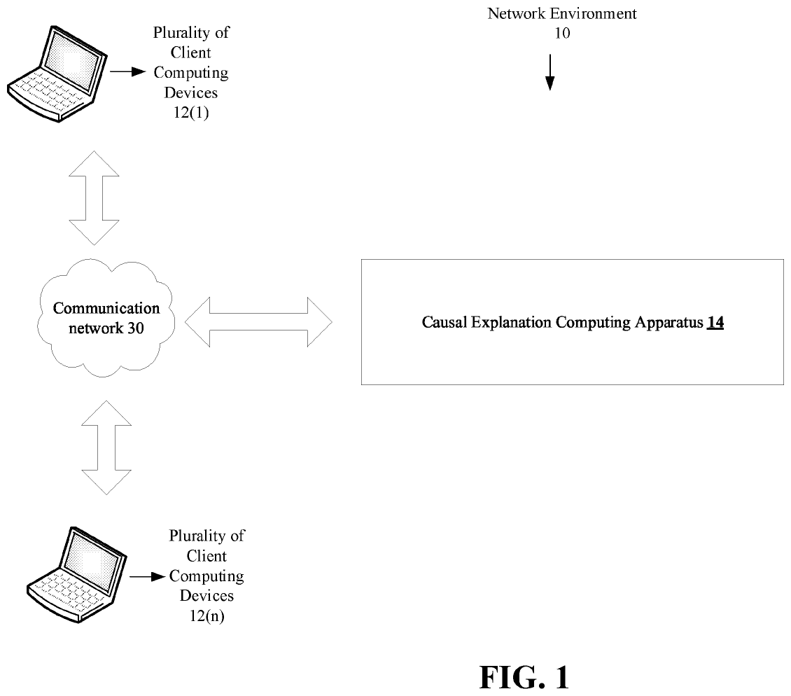

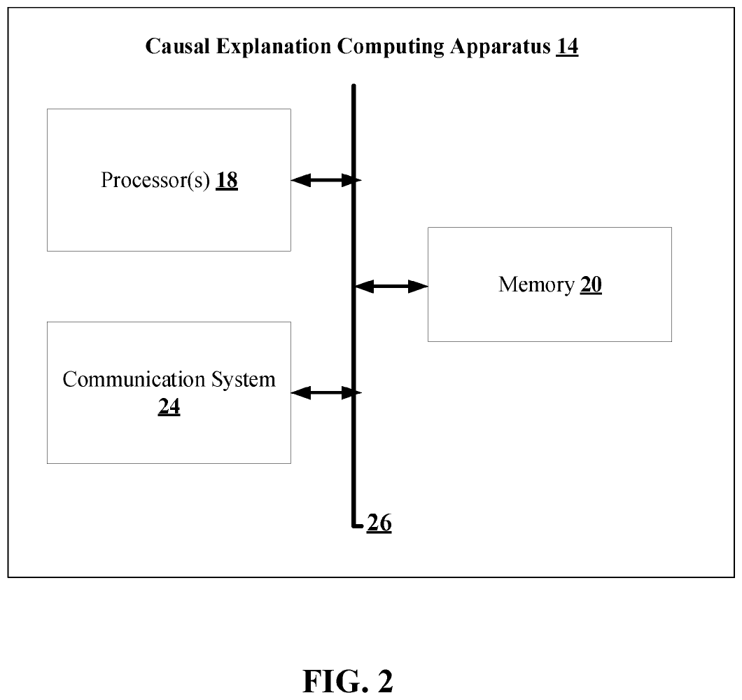

An environment 10 with an example of a causal explanation computing apparatus 14 is illustrated in FIGS. 1-2. In this particular example, the environment 10 includes the causal explanation computing apparatus 14 and client computing devices 12(1)-12(n), coupled via one or more communication networks 30, although the environment could include other types and numbers of systems, devices, components, and/or other elements as is generally known in the art and will not be illustrated or described herein. This technology provides a number of advantages including providing methods, non-transitory computer readable medium, and apparatuses that generates and provides causal explanations of artificial intelligence models.

Referring more specifically to FIGS. 1-2, the causal explanation computing apparatus 14 is programmed to generate and provide causal explanations of artificial intelligence models, although the apparatus can perform other types and/or numbers of functions or other operations and this technology can be utilized with other types of claims. In this particular example, the causal explanation computing apparatus 14 includes a processor 18, a memory 20, and a communication system 24 which are coupled together by a bus 26, although the causal explanation computing apparatus 14 may comprise other types and/or numbers of physical and/or virtual systems, devices, components, and/or other elements in other configurations.

The processor 18 in the causal explanation computing apparatus 14 may execute one or more programmed instructions stored in the memory 20 for improving the accuracy of automated vehicle valuations as illustrated and described in the examples herein, although other types and numbers of functions and/or other operations can be performed. The processor 18 in the causal explanation computing apparatus 14 may include one or more central processing units and/or general purpose processors with one or more processing cores, for example.

The memory 20 in the causal explanation computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication system 24 in the causal explanation computing apparatus 14 operatively couples and communicates between one or more of the client computing devices 12(1)-12(n) and one or more of the plurality of data servers 16(1)-16(n), which are all coupled together by one or more of the communication networks 30, although other types and numbers of communication networks or systems with other types and numbers of connections and configurations to other devices and elements. By way of example only, the communication networks 18 can use TCP/IP over Ethernet and industry-standard protocols, including NFS, CIFS, SOAP, XML, LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the client computing devices 12(1)-12(n) may submit requests for explanation of an output of the artificial intelligence models by the causal explanation computing apparatus 14, although other types of can be obtained by the causal explanation computing apparatus 14 in other manners and/or from other sources. Each of the client computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

Although the exemplary network environment 10 with the causal explanation computing apparatus 14, the plurality of client computing devices 12(1)-12(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

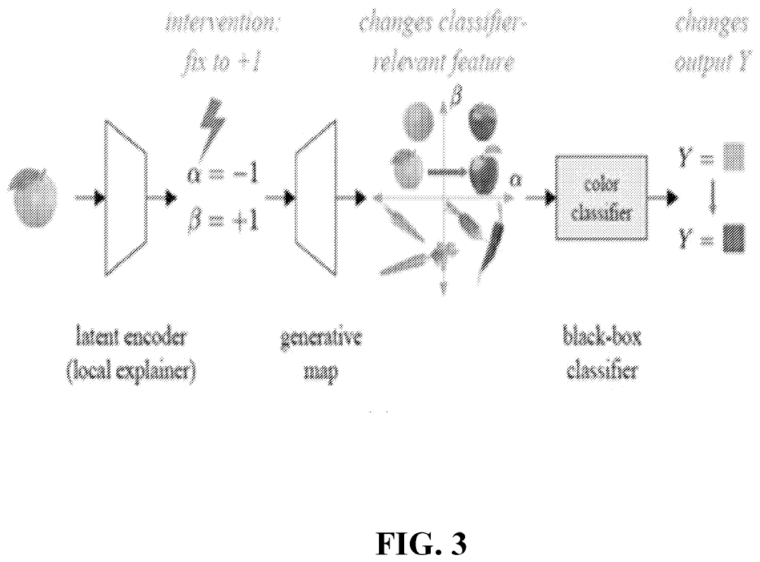

The technology discloses a method to represent and move within the data distribution, and a rigorous metric for causal influence of different data aspects on the classifier output. To do this, the causal explanation computing apparatus 14 constructs a generative model consisting of a disentangled representation of the data and a generative mapping from this representation to the data space as shown in FIG. 3, by way of example. Further, the causal explanation computing apparatus 14 learns the disentangled representation in such a way that each factor controls a different aspect of the data, and a subset of the factors have a large causal influence on the classifier output. To formalize this notion of causal influence, the causal explanation computing apparatus 14 defines a structural causal model (SCM) that relates independent latent factors defining data aspects, the data samples that are input to the classifier, and the classifier outputs. Accordingly, in the disclosed technology, the approach is an optimization program for learning a mapping from the latent factors to the data space. The objective of the optimization program ensures that the learned disentangled representation represents the data distribution while simultaneously encouraging a subset of latent factors to have a large causal influence on the classifier output.

The disclosed technology provides an advantage of providing an accurate and flexible vocabulary for explanation through learning the disentangled representation. This vocabulary can be more expressive than feature selection or saliency map-based explanation methods: a latent factor, in its simplest form, could describe a single feature or mask of features in input space, but it can also describe much more complex patterns and relationships in the data. More importantly, the generative model enables the causal explanation computing apparatus to construct explanations that respect the data distribution. This is important because an explanation is only meaningful if it describes combinations of data aspects that naturally occur in the dataset. For example, a loan applicant would not appreciate being told that his loan would have been approved if he had made a negative number of late payments, and a doctor would be displeased to learn that an automated diagnosis system depends on a biologically implausible attribute.

Once the generative mapping defining the disentangled representation is learned, explanations can be constructed using the generative mapping. The disclosed technology can provide both global and local explanations: a practitioner can understand the aspects of the data that are important to the classifier at large by visualizing the effect in data space of changing each causal factor, and they can determine the aspects that dictated the classifier output for a specific input by observing its corresponding latent values. These visualizations can be much more descriptive than saliency maps, particularly in vision applications.

The method that generates post-hoc explanations of artificial intelligence model will now be illustrated. With respect to the forms of the explanation, in the disclosed technology, explanations consist of a low-dimensional set of latent factors that describe different aspects (or “concepts”) of the data. These latent factors form a rich and flexible vocabulary for both global and local explanations, and provide a means to represent the data distribution. The disclosed technology does not require side information defining data aspects. In contrast, the disclosed technology visualizes the learned aspects using a generative mapping to the data space.

With reference to the causality in explanation, the disclosed technology uses notions of causality and are constructs explanation directly from identified latent factors. The method disclosed, is unique in constructing a framework from principles of causality that generates latent factor-based explanations of artificial intelligence models without requiring side information that defines data aspects to be used for explanation.

The disclosed technology can also be interpreted as a disentanglement procedure supervised by classifier output probabilities. In this perspective, the disclosed technology separates latent factors that are relevant to the classifier's decision from those that are irrelevant.

In the disclosed technology, the causal explanation computing apparatus 14 takes ab artificial intelligence classifier model f: [symbol] → [symbol] that takes data samples X ∈ [symbol] and assigns a probability to each class Y ∈{1, . . . , M}, (i.e., [symbol] is the M-dimensional probability simplex). Additionally, in the disclosed technology, it is assume that the classifier also provides the gradient of each class probability with respect to the classifier input. Further, in the disclosed technology, the causal explanations take the form of a low-dimensional and independent set of “causal factors” α∈ [symbol] K that, when changed, produce a corresponding change in the classifier output statistics. Additionally, the disclosed technology allows for additional independent latent factors β∈ [symbol] L that contribute to representing the data distribution but need not have a causal influence on the classifier output. Together, (α, β) constitute a low-dimensional representation of the data distribution p(X) through the generative mapping g: [symbol] K+L→ [symbol] . The generative mapping is learned so that the explanatory factors a have a large causal influence on Y, while α and β together faithfully represent the data distribution (i.e., p(g(α, β))≈p(X)). The a learned in this manner can be interpreted as aspects causing f to make classification decisions.

Next, to learn a generative mapping with these characteristics, the causal explanation computing apparatus 14 defines (i) a model of the causal relationship between α, β, X, and Y , (ii) a metric to quantify the causal influence of α on Y, and (iii) a learning framework that maximizes this influence while ensuring that p(g(α, β))≈p(X).

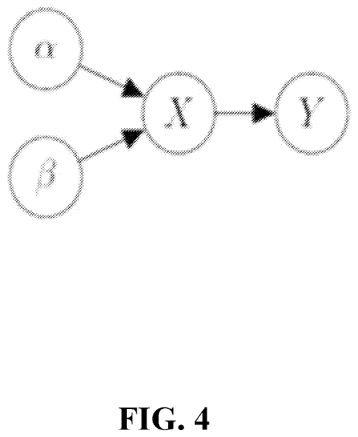

With respect to the causal model, the causal explanation computing apparatus 14 first defines a directed acyclic graph (DAG) [symbol] the relationship between (α, β), X, and Y, which allows a metric of causal influence of α on Y to be derived. In this example, the causal explanation computing apparatus 14 uses the following parameters to select the DAG, although other parameters can be used to select the DAG in other examples. First, the DAG should describe the functional (causal) structure of the data, not simply the statistical (correlative) structure. This principle allows the DAG to be interpreted as a structural causal model and explanations to be interpreted causally. Second, the explanation should be derived from the classifier output Y, not the ground truth classes. Using the second principle, the causal explanation computing apparatus 14 understands the action of the classifier, not the ground truth classes. Third, the DAG should contain a (potentially indirect) causal link from X to Y. This principle ensures that the causal model adheres to the functional operation of f:X→Y. Based on these principles, the disclosed technology adopts the DAG as shown in FIG. 4, by way of example. In the disclosed technology, the differences between α and β arise from the fact that the functional relationship defining the causal connection X→Y is f, which by construction uses only features of X that are controlled by α. In other words, interventions on both α and β produce changes in X, but only interventions on α produce changes in Y. In the disclosed technology, a key feature of this example DAG is that the latent factors (α, β) are independent. By using this technique, this feature improves the parsimony and interpretability of the learned disentangled representation.

A method for deriving a metric [symbol] (α, Y) for the causal influence of α on Y using [symbol] in FIG. 4 will now be illustrated. In the disclosed technology, the causal explanation is required to satisfy the following principles. First, the metric should completely capture functional dependencies. This principle allows the disclosed technology to capture the complete causal influence of α on Y through the generative mapping g and classifier f, which may both be defined by complex and nonlinear functions such as neural networks. Second, the metric should quantify indirect causal relationships between variables. This principle allows the disclosed technology to quantify the indirect causal relationship between α and Y.

In this example, the first principle eliminates common metrics such as the average causal effect and analysis of variance, which capture only causal relationships between first- and second-order statistics, respectively. The information flow metric adapts the concept of mutual information typically used to quantify statistical influence to quantify causal influence by the observational distributions in the standard definition of conditional mutual information with interventional distributions:

Definition 1: Let U and V be disjoint subsets of nodes. The information flow from U to V is

$$I ( U \to V ) := {\int }_{U} p ( u ) {\int }_{V} p ( v \vert do ( u ) ) log \frac{p ( v \vert do ( u ) )}{{\int }_{{u}^{′}} p ( {u}^{′} ) p ( v \vert do ( {v}^{′} ) ) {du}^{′}} dV dU , \qquad ( 1 )$$

where do(u) represents an intervention in a causal model that fixes u to a specified value regardless of the values of its parents. The independence of (α, β) makes it simple to show that information flow and mutual information coincide in the DAG selected and represented in FIG. 4, by way of example.

That is, I(α→Y)=I (α; Y), where mutual information is defined as

$$O ( α ; Y ) = 𝔼α , {Y}^{[ log \frac{p ( α , Y )}{p ( α ) p ( Y )} ]} .$$

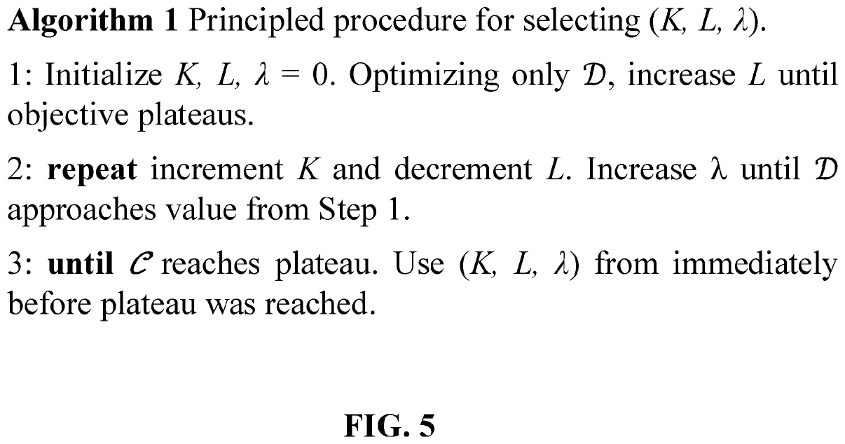

An algorithm to select the parameters K, L, and λ is illustrated in FIG. 5, by way of example.

Based on this result, the disclosed technology uses

C(α, Y)=I(α; Y) (2)

to quantify the causal influence of α on Y. Additionally, the disclosed technology generates explanations that benefit from both causal and information-theoretic perspectives. In this example, the validity of the causal interpretation is predicated on the modeling decisions; mutual information is in general a correlational, not causal, metric.

Other variants of (conditional) mutual information are also compatible with the disclosed technology. These variants retain causal interpretations, but produce explanations of a slightly different character. For example,

$${\sum }_{i = 1}^{K} O ( α i ; Y )$$

and I(α; Y|β) encourage interactions between the explanatory features to generate X.

Now, a method for learning a generative mapping will be illustrated. In the disclosed technology, an optimization program is used to learn a generative mapping g: (α, β)→X such that p(g(α,β))≈p(X), the (α, β) are independent, and a has a large causal influence on Y. The disclosed technology learns the generative mapping by solving,

$${arg max}_{g ∈ G} 𝒞 ( α , Y ) + λ \cdot 𝒟 ( p ( g ( α , β ) ) , p ( X ) ) , \qquad ( 3 )$$

where g is a function in some class G, [symbol] (α, Y) is a metric for the causal influence of α on Y from (2), and [symbol] (p(g(α, β)), p(X)) is a measure of the similarity between p(g(α, β)) and p(X).

In the disclosed technology, the use of [symbol] is a crucial feature because it forces g to produce samples that are in the data distribution p(X). Without this property, the learned causal factors could specify combinations of aspects that do not occur in the dataset, providing little value for explanation. The specific form of [symbol] is dependent on the class of decoder models G.

In this example, training causal explanatory model requires selecting K and L, which define the number of latent factors, and λ, which trades between causal influence and data fidelity in the objective. A proper selection of these parameters should set λ sufficiently large so that the distributions p(X|α, β) used to visualize explanations lie in the data distribution p(X), but not so high that the causal influence term is overwhelmed.

To properly navigate this trade-off it is instructive to view equation (3) as a constrained problem in which [symbol] is maximized subject to an upper bound on D. Further, the algorithm illustrated in FIG. 5 provides a principled method for parameter selection based on this idea. First, the total number of latent factors needed to adequately represent p(X) is selected using only noncausal factors. Steps 2-3 then incrementally convert noncausal factors into causal factors until the total explanatory value of the causal factors (quantified by [symbol] ) plateaus. Because changing K and L affects the relative weights of the causal influence and data fidelity terms, λ should be increased after each increment to ensure that the learned representation continues to satisfy the data fidelity constraint.

With reference to the disentanglement procedures, first, the disclosed technology uses classifier probabilities to aid disentanglement. The disclosed technology then uses properties of the variational auto-encoder evidence lower bound to show that the commonly-used MI metric measures causal influence of α on Y using the information flow metric. By using this fact, the disclosed technology provides a causal interpretation for information-based disentanglement methods.

Next, an instructive setting is described in which a linear generative mapping is used to explain simple classifiers with decision boundaries defined by hyperplanes. This setting admits geometric intuition and basic analysis that illuminates the function of the optimization program objective. In this example, the data distribution is defined as an isotropic normal in [symbol] N, X˜ [symbol] (0, I). Let (α, β)˜(0, I), and consider the following generative model to be used for constructing explanations:

$$g ( α , β ) = [ {W}_{α} {W}_{β} ] [ \begin{matrix}α \\ β\end{matrix} ] + ε ,$$

where Wα∈RN×K, Wβ∈ [symbol] N×L, and ε˜ [symbol] (0, γI). The behavior of the disclosed technology is illustrated with an application to this generative model on two simple binary classifiers (Y∈{0, 1}).

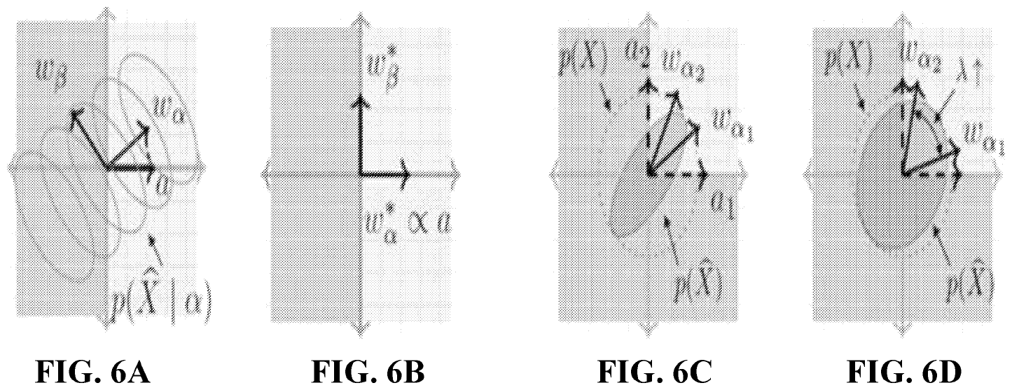

In this example, FIGS. 6A-6B illustrates simple classifiers in [symbol] 2. As illustrated in FIG. 6A, visualizing the conditional distribution p(\hat{X}|α) provides intuition for the linear-Gaussian model. FIG. 6B linear classifier with yellow encoding high probability of y=1 (right side of the graph), and blue encoding high probability of y=0 (left side of the graph). Proposition 3 shows that the optimal solution to (3) is w_{α}* ∝ a and w_{β}*⊥w_{α}* for λ>0. With reference to FIGS. 6C-6D, for the “and” classifier, varying λ trades between causal alignment and data representation.

With reference to example of linear classifiers, consider first a linear separator p(y=1|x)=σ(aT x), where a ∈ [symbol] N denotes the decision boundary normal and cr is a sigmoid function (visualized in [symbol] 2 in FIG. 6A). With a single causal and single noncausal factor (K=L=1), learning an explanation consists of finding the wα, wβ ∈ [symbol] 2 that maximize the optimization program described above. Intuitively, the disclosed technology expects wα to align with a because this direction allows a to produce the largest change in classifier output statistics. This can be seen by considering the distribution p(\hat{X}|α) depicted in FIG. 6A, where \hat{X}=g(α, β). Since the generative model is linear-Gaussian, varying α translates p(\hat{X}|α) along the direction wα. When this direction is more aligned with the classifier normal α, interventions on α cause a larger change in classifier output by moving p(\hat{X}|α) across the decision boundary. Because the data distribution is isotropic, the disclosed technology expects D to achieve its maximum when wβ is orthogonal to wα, allowing wα and wβ to perfectly represent the data distribution. By combining these two insights, the solution of (3) is given by w_{α}*∝α and w_{β}*⊥w_{α}* (as illustrated in FIG. 6B).

Now with reference to the an “And” classifier, the disclosed technology considers the slightly more complex “and” classifier parameterized by two orthogonal hyperplane normal a1, a2 ∈ [symbol] 2 (represented in FIG. 6C given by p(Y=1|x)=σ(α₁^{T}α)·σ(α₂^{T}α). This classifier assigns a high probability to Y=1 when both α₁^{T}x>0 and α₂^{T}x>0. Here, the disclosed technology uses K=2 causal factors and L=0 non-causal factors to illustrate the role of λ in trading between the terms in the objective. In this setting, learning an explanation entails finding the wα1, wα2 ∈ [symbol] that maximize optimization program described above.

Further, FIGS. 6C-6D, depicts the effect of λ on the learned wα1, wα2. Unlike in the linear classifier case, when explaining the “and” classifier there is a tradeoff between the two terms in the objective of the optimization program described above: the causal influence term encourages both wα1 and wα2 to point towards the upper right-hand quadrant of the data space, the direction that produces the largest variation in class output probability. On the other hand, the isotropy of the data distribution results in the data fidelity term encouraging orthogonality between the factor directions. Therefore, when λ is small the causal effect term dominates, aligning the causal factors to the upper right-hand quadrant of the data space as illustrated in FIG. 6C. As λ increases as illustrated in FIG. 6D, the larger weight on the data fidelity term encourages orthogonality between the factor directions so that the distribution of the reconstructed p(\hat{X}) more closely approximates the dataset distribution p(\hat{X}). This example illustrates how λ must be selected carefully to represent the data distribution while learning meaningful explanatory directions.

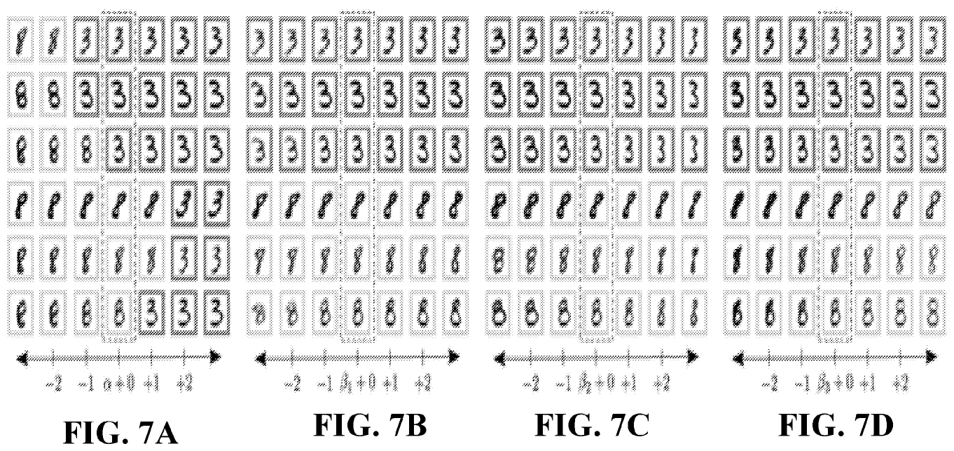

Next, the disclosed technology will be illustrated by generating explanations of convolutional neural network (CNN) classifiers trained on image recognition tasks. In this setting the class of generative mappings G will be a set of neural networks, and the VAE architecture shown in FIG. 3A will be used to learn g. In this example, the causal explanation computing apparatus 14 trains a CNN classifier with two convolutional layers followed by two fully connected layers on 3 and 8 digits from the MNIST dataset. Using the parameter tuning procedure described the algorithm illustrated in FIG. 5, the causal explanation computing apparatus 14 selects K=1 causal factor, L=7 noncausal factors, and λ=0.05. FIG. 7A illustrates the global explanation for this classifier and dataset, which visualizes how g(α, β) changes as α is modified. In this example, α controls the features that differentiate the digits 3 and 8, so changing α changes the classifier output while preserving stylistic features irrelevant to the classifier such as skew and thickness. By contrast, FIG. 7B-7D illustrates that changing each pi affects stylistic aspects such as thickness and skew but not the classifier output.

In the examples illustrated in FIGS. 7A-7D, changing the causal factor a provides the global explanation of the classifier. Images in the center column of each grid are reconstructed samples from the validation set; moving left or right in each row shows g(α, β) as a single latent factor is varied. Changing the learned causal factor α affects the classifier output. (FIGS. 7B-7D) Changing the noncausal factors {βi} affects stylistic aspects such as thickness and skew but does not affect the classifier output. By using this technique, the disclosed technology is able to differentiate causal aspects (pixels that define 3 from 8) from purely stylistic aspects (here, rotation).

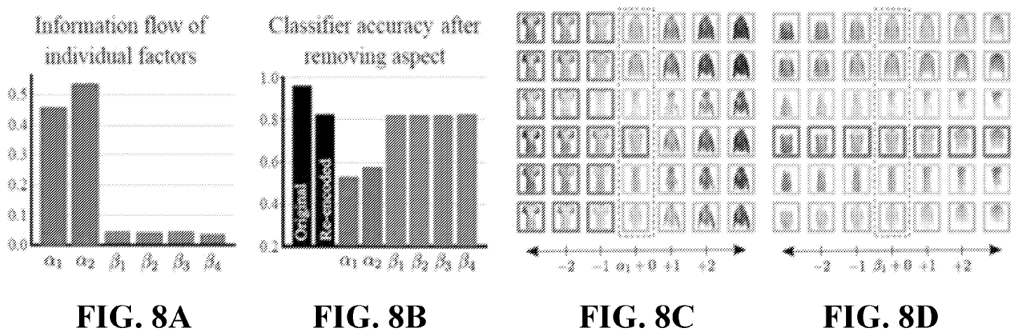

In another example illustrated in FIGS. 8A-8D, FIG. 8A illustrates information flow of each latent factor on the classifier output statistics. Next, FIG. 8B illustrates the classifier accuracy when data aspects controlled by individual latent factors are removed, showing that learned first latent factors αi (but not other latent factors βi) control data aspects relevant to the classifier. FIGS. 8C-8D illustrates, modifying al changes the classifier output, while modifying β1 does not. In this example, the causal explanation computing apparatus 14 learns explanations of a CNN trained to classify t-shirt, dress, and coat images from the fashion MNIST dataset. Following the parameter selection procedure illustrated in algorithm represented in FIG. 5, the causal explanation computing apparatus 14 selects K=2, L=4, and λ=0.05. Further, the causal explanation computing apparatus 14 evaluates the efficacy of the explanations in this setting using two quantitative metrics. First, the causal explanation computing apparatus 14 computes the information flow from each latent factor to the classifier output Y. In this example, FIG. 8A illustrates that, as desired, the information flow from α to Y is large while the information flow from β to Y is small. Second, the causal explanation computing apparatus 14 evaluates the reduction in classifier accuracy after individual aspects of the data are removed by fixing a single latent factor in each validation data sample to a different random value drawn from the prior [symbol] (0, 1). This test is frequently used as a metric for explanation quality; the disclosed technology has the advantage of removing certain data aspects while remaining in-distribution rather than crudely removing features by masking (super) pixels. Further, FIG. 8B illustrates this reduction in classifier accuracy. In the disclosed technology, changing aspects controlled by learned causal factors indeed significantly degrades the classifier accuracy, while removing aspects controlled by noncausal factors has only a negligible impact on the classifier accuracy. FIGS. 8C-8D visualizes the aspects learned by α1 and β1. As before, only the aspects of the data controlled by a are relevant to the classifier: changing α1 produces a change in the classifier output, while changing β1 affects only aspects that do not modify the classifier output.

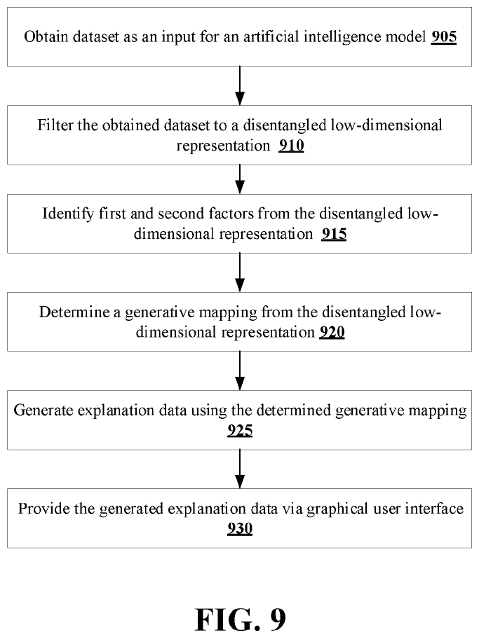

An example of a method for generating and providing causal explanations of artificial intelligence models will now be described with reference to FIG. 9 using the techniques discussed above. While the flowchart in FIG. 9 is illustrated as sequence of steps, it is to be understood that either some or all of the steps can be executed simultaneously. In particular, the exemplary method begins at step 905 where the causal explanation computing apparatus 14 obtains a dataset as an input for an artificial intelligence model. In this example, the causal explanation computing apparatus 14 can obtain the dataset from a data server (not shown), although the dataset can be obtained from other sources or locations.

Additionally, in this example, the dataset that is obtained is of higher level of dimension. Next in step 910, the causal explanation computing apparatus 14 filters the obtained dataset to a disentangled low-dimensional representation. Further, in step 915, the causal explanation computing apparatus 14 identifies first and second factors from the disentangled low-dimensional representation. Furthermore, in step 920, the causal explanation computing apparatus 14 determines a generative mapping from the disentangled low-dimensional representation. Additionally, in step 925, the causal explanation computing apparatus 14 generates explanation data using the determined generative mapping. In step 930, the causal explanation computing apparatus 14 provides the generated explanation data via graphical user interface.

Additionally, the causal explanation computing apparatus 14 learns the generated generative mapping data to generate the explanation data comprising the one or more decision factors. To learn, the causal explanation computing apparatus 14 defines a causal model representing a relationship between the identified plurality of first factors, the plurality of second factors, and the output of the artificial intelligence model. Additionally, the causal explanation computing apparatus 14 defines a quantifying metric to quantify the causal influence of the identified plurality of first factors on the output of the artificial intelligence model and also defines a learning framework. In this example, defining the causal model involves describing a functional causal structure of the dataset, and deriving an explanation from an indirect causal link from the identified plurality of first factors and the output of the artificial intelligence model. Additionally, in this example, the quantifying metric is defined considering a factor to capture functional dependencies and quantify indirect causal relationship between the identified plurality of first factors and the output of the artificial intelligence model. Further, a plurality of second factors within the obtained data is identified by the causal explanation computing apparatus 14 wherein the identified plurality of second factors have lesser impact on the output of the artificial intelligence model when compared to the identified plurality of first factors. In other words, the plurality of second factors does not have an impact on the output of the artificial intelligence model.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure. Accordingly, the invention is limited only by the following claims and equivalents thereto.

1. A method comprising: identifying first factors from a disentangled low-dimensional representation of a dataset that affect an output of an artificial intelligence model;
determining a generative mapping from the disentangled low-dimensional representation between the identified first factors and the output of the artificial intelligence model, using causal reasoning; and
generating explanation data using the determined generative mapping, wherein the generated explanation data provides a description of an operation leading to the output of the artificial intelligence model using the identified first factors.

2. The method of claim 1 further comprising:
learning the generated generative mapping to generate the explanation data;
providing the generated explanation data via a graphical user interface; and
identifying second factors within the dataset, wherein the identified second factors have a lesser impact on the output of the artificial intelligence model when compared to the identified first factors.

3. The method of claim 2, wherein the learning comprises:
defining a causal model representing a relationship between the identified first factors, the second factors, and the output of the artificial intelligence model;
defining a quantifying metric to quantify the causal influence of the identified first factors on the output of the artificial intelligence model; and
defining a learning framework.

4. The method of claim 1 further comprising:
obtaining, by a causal explanation computing apparatus, the dataset as an input for the artificial intelligence model, wherein the obtained dataset is filtered to the disentangled low-dimensional representation; and
providing, by the causal explanation computing apparatus, the generated explanation data via a graphical user interface;
wherein the identifying, determining and generating are each by the causal explanation computing apparatus.

5. The method of claim 4 further comprising:
learning, by the causal explanation computing apparatus, the generated generative mapping to generate the explanation data comprising:
defining, by the causal explanation computing apparatus, a causal model representing a relationship between the identified first factors, the second factors, and the output of the artificial intelligence model;
defining, by the causal explanation computing apparatus, a quantifying metric to quantify the causal influence of the identified first factors on the output of the artificial intelligence model; and
defining, by the causal explanation computing apparatus, a learning framework; and
identifying, by the causal explanation computing apparatus, second factors within the obtained dataset, wherein the identified second factors have a lesser impact on the output of the artificial intelligence model when compared to the identified first factors;
wherein the quantifying metric is defined considering a factor to capture functional dependencies and quantify indirect causal relationship between the identified first factors and the output of the artificial intelligence model;
wherein the defining the causal model comprises:
escribing a functional causal structure of the dataset; and
deriving an explanation from an indirect causal link from the identified first factors and the output of the artificial intelligence model; and
wherein the quantifying metric is defined considering a factor to capture functional dependencies and quantify indirect causal relationship between the identified first factors and the output of the artificial intelligence model.

6. The method of claim 2, wherein the identified second factors do not affect the output of the artificial intelligence model.

7. A non-transitory machine readable medium having stored thereon instructions comprising machine executable code which when executed by at least one machine causes the machine to:
obtain a dataset as an input for an artificial intelligence model, wherein the obtained dataset is filtered to a disentangled low-dimensional representation;
identify a plurality of first factors from the disentangled low-dimensional representation of the obtained data that affect an output of the artificial intelligence model;
determine a generative mapping from the disentangled low-dimensional representation between the identified plurality of first factors and the output of the artificial intelligence model, using causal reasoning;
generate explanation data using the determined generative mapping, wherein the generated explanation data wherein the generated explanation data provides a description of an operation leading to the output of the artificial intelligence model using the identified plurality of first factors; and
provide the generated explanation data via a graphical user interface.

8. The medium of claim 7, wherein the instructions, when executed, further causes the machine to:
learn the generated generative mapping data to generate the explanation data; and
identify a plurality of second factors within the obtained data, wherein the identified plurality of second factors have lesser impact on the output of the artificial intelligence model when compared to the identified plurality of first factors.

9. The medium of claim 8, wherein the instructions, when executed, further causes the machine to:
define a causal model representing a relationship between the identified plurality of first factors, the plurality of second factors, and the output of the artificial intelligence model;
define a quantifying metric to quantify the causal influence of the identified plurality of first factors on the output of the artificial intelligence model; and
define a learning framework.

10. The medium of claim 9, wherein the instructions, when executed, further causes the machine to:
describe a functional causal structure of the dataset; and
derive an explanation from an indirect causal link from the identified plurality of first factors and the output of the artificial intelligence model.

11. The medium of claim 9, wherein the instructions, when executed, further causes the machine to:
define the quantifying metric considering a factor to capture functional dependencies and quantify indirect causal relationship between the identified plurality of first factors and the output of the artificial intelligence model.

12. The medium of claim 8, wherein the identified plurality of second factors does not affect the output of the artificial intelligence model.

13. A casual explanation computing apparatus comprising:
a memory containing machine readable medium comprising machine executable code having stored thereon instructions for managing workload within a storage system; and
a processor coupled to the memory, the processor configured to execute the machine executable code to cause the processor to:
obtain a dataset as an input for an artificial intelligence model, wherein the obtained dataset is filtered to a disentangled low-dimensional representation;
identify a plurality of first factors from the disentangled low-dimensional representation of the obtained data that affect an output of the artificial intelligence model;
determine a generative mapping from the disentangled low-dimensional representation between the identified plurality of first factors and the output of the artificial intelligence model, using causal reasoning;
generate explanation data using the determined generative mapping, wherein the generated explanation data provides a description of an operation leading to the output of the artificial intelligence model using the identified plurality of first factors; and
provide the generated explanation data via a graphical user interface.

14. The causal explanation computing apparatus of claim 13, wherein the processor is further configured to execute the machine executable code to further cause the processor to:
learn the generated generative mapping data to generate the explanation data; and
identify a plurality of second factors within the obtained data, wherein the identified plurality of second factors have lesser impact on the output of the artificial intelligence model when compared to the identified plurality of first factors.

15. The causal explanation computing apparatus of claim 14, wherein the processor is further configured to execute the machine executable code to further cause the processor to learn, wherein the learning further comprises:
define a causal model representing a relationship between the identified plurality of first factors, the plurality of second factors, and the output of the artificial intelligence model;
define a quantifying metric to quantify the causal influence of the identified plurality of first factors on the output of the artificial intelligence model; and
define a learning framework.

16. The causal explanation computing apparatus of claim 15, wherein the defining the causal model comprises:
describing a functional causal structure of the dataset; and
deriving an explanation from an indirect causal link from the identified plurality of first factors and the output of the artificial intelligence model.

17. The causal explanation computing apparatus of claim 15, wherein the quantifying metric is defined considering a factor to capture functional dependencies and quantify indirect causal relationship between the identified plurality of first factors and the output of the artificial intelligence model.

18. The causal explanation computing apparatus of claim 14, wherein the identified plurality of second factors does not affect the output of the artificial intelligence model.
